(19) United States
(12) Patent Application Publication
(10) Pub. No.: US 2016/0239490 A1
(43) Pub. Date: Aug. 18, 2016

(54) Using Alternate Words As an Indication of Word Sense

(71) Applicant: Google, Inc., (US)

(72) Inventors: Kedar Dhamdhere, Sunnyvale, CA (US); John Ogden Lamping, Los Altos, CA (US); Paul A. Tucker, Los Altos, CA (US)

(73) Assignee: Google Inc., Mountain View, CA (US)

(21) Appl. No.: 13/763,198

(22) Filed: Feb. 8, 2013

(51) Int. Cl. G06F 17/30

(52) U.S. Cl. CPC G06F 17/3053

(57) ABSTRACT

Methods, systems, and apparatus, including computer programs encoded on a computer storage medium, for using alternate words as an indication of word sense. In one aspect, a method includes identifying a particular term. The method further includes identifying a first alternate term and a second alternate term for the particular term, and identifying a first sequence of terms that occurs in a text corpus, and includes the particular term among its terms. The method further includes determining a number of occurrences of a second sequence of terms in the text corpus. The second sequence of terms differs from the first sequence of terms only in that the first alternate term is substituted for the particular term and determining a number of occurrences of a third sequence of terms in the text corpus. The third sequence of terms differs from the first sequence of terms.

### TECHNICAL FIELD

This specification generally relates to search engines, and one example implementation relates to expanding search queries to include terms that are substitutes for query terms.

### BACKGROUND

A homonym is one of a group of words that share the same spelling and the same pronunciation, but have different, unrelated meanings or senses. In the English language, the homonym “bow” could refer to a long wooden stick with horse hair that is used to play certain string instruments such as the violin, or to the act of bending forward at the waist in respect. Homonyms are both homographs, i.e., words that share the same spelling regardless of their pronunciation, and homophones, i.e., words that share the same pronunciation regardless of their spelling.

A polyseme, or polysemous word, refers to one of a group of words that share the same spelling and the same pronunciation, and have different, but related meanings or senses. In the English language, for example, the polyseme “man” could refer to the human species in general, to males of the human species, or to adult males of the human species.

### SUMMARY

A search system can distinguish the senses of the original term based on how, or the extent to which, an original term alternates with alternate terms for the original term, in context. For instance, the search system may evaluate alternate search queries which differ from an original search query only in that the given term has been replaced by alternate terms, under the assumption that the replacement of the original term by the alternate terms depends upon the sense of the original term.

According to an innovative aspect of the subject matter described in this specification, a search system can identify sets of terms (referred to as a set of “alternate terms” or “alternations”) that are associated with a particular sense of a homograph or a polysemous term which, by definition, has multiple senses. Using data gathered from previous search queries, the search system can determine a relationship between a given query term that is a homograph or polysemous term (referred to by this specification as “the original term”) and an alternate term for the homograph or polysemous term (referred to by this specification as “the first alternate term,” or “the first candidate alternation”).

In one example implementation, the search system determines a likelihood of the query log containing one or more search queries created by replacing the homograph or polysemous term with a different, alternate term for the homograph or polysemous term (referred to by this specification as “the second alternate term,” or “the second alternation”), when the a search query that is formed by replacing the homograph or polysemous term with the first alternate term for the homograph or polysemous term has also been observed in the query log.

This likelihood is used to define a set of candidate alternations for the original term when the original term occurs in the particular sense. With the set of candidate alternations for the particular sense of the original term, the search system can, given a candidate substitute term for an original term, identify whether the candidate substitute term indicates the same, particular sense of the original term. If so, the search system can then expand a search query that includes the original term to include the candidate substitute term, to enhance the results of the search query.

In general, another innovative aspect of the subject matter described in this specification may be embodied in methods that include the actions of identifying a particular term; identifying a first alternate term and a second alternate term for the particular term; identifying a first sequence of terms that (i) occurs in a text corpus, and (ii) includes the particular term among its terms; determining a number of occurrences of a second sequence of terms in the text corpus, wherein the second sequence of terms differs from the first sequence of terms only in that the first alternate term is substituted for the particular term; determining a number of occurrences of a third sequence of terms in the text corpus, wherein the third sequence of terms differs from the first sequence of terms only in that the second alternate term is substituted for the particular term; and determining, based at least on the number of occurrences of the second sequence of terms in the text corpus and the number of occurrences of the third sequence of terms in the text corpus, whether the first alternate term and the second alternate term indicate a same word sense of the particular term.

These and other embodiments can each optionally include one or more of the following features. The particular term includes a term of search query. The first alternate term or the second alternate term includes a candidate substitute for the particular term. The text corpus includes a query log. Each sequence of terms includes a search query. The actions further include receiving a search query that includes the particular term. The particular term, the first alternate term, and the second alternate term are identified after the search query is received.

The actions further include, after determining whether the first alternate term and the second alternate term indicate a same word sense of the particular term, receiving a search query that includes the particular term; and determining whether to expand the search query to include the first alternate term or the second alternate term based on determining whether the first alternate term and the second alternate term indicate a same word sense of the particular term. Determining whether the first alternate term and the second alternate term indicate a same sense of the particular term includes determining whether second sequence of terms and the third sequence of terms both occur in the text corpus. Determining whether the first alternate term and the second alternate term indicate a same sense of the particular term includes determining whether second sequence of terms and the third sequence of terms both occur in the text corpus more than a predetermined number of times.

The actions further include identifying a fourth sequence of terms that (i) occurs in the text corpus, and (ii) includes the particular term among its terms, wherein the fourth sequence of terms is different than the first sequence of terms; determining a number of occurrences of a fifth sequence of terms in the text corpus, wherein the fifth sequence of terms differs from the fourth sequence of terms only in that the first alternate term is substituted for the particular term; determining a number of occurrences of a sixth sequence of terms in the text corpus, wherein the sixth sequence of terms differs from the fourth sequence of terms only in that the second alternate term is substituted for the particular term; and wherein determining whether the first alternate term and the second alternate term indicate the same word sense of the particular term is further based on the number of occurrences of the fifth sequence of terms in the text corpus and the number of occurrences of the sixth sequence of terms in the text corpus.

The actions further include comparing the number of occurrences of the second sequence of terms in the text corpus with the number of occurrences of the third sequence of terms in the text corpus; and generating a score for a substitution of the particular term by the first alternate term or the second alternate term based on comparing the number of occurrences of the second sequence of terms in the text corpus with the number of occurrences of the third sequence of terms in the text corpus. The first alternate term or the second alternate term are identified after determining that the particular term includes a homograph or polysemous term.

Other embodiments of this aspect include corresponding systems, apparatus, and computer programs recorded on computer storage devices, each configured to perform the operations of the methods.

Particular embodiments of the subject matter described in this specification can be implemented so as to realize one or more of the following advantages. The correct sense of an original term of a search query can be identified, and the search system can avoid expanding the search query to include candidate substitute terms that are associated with different senses. The correct sense of a resource, e.g., a web page, can be identified, based on identifying the correct senses of the terms used in the resource. In any case, the search system can identify search results that better match a user's intent.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system that uses alternate terms to generate search results.

FIGS. 2 and 3 are flowcharts that show example methods for identifying words that are appropriate substitutes for a particular word, when the particular word is being used in a particular word sense.

FIGS. 4 and 5 show the example contents of a query log

Like reference numbers and designations in the various drawings indicate like elements throughout.

### DETAILED DESCRIPTION

Overview

Polysemous words can be a challenge for a search system to process. For instance, if a substitution of a particular candidate substitute for an original term is contemplated, the search system must deal with the fact that the original term and the particular candidate substitute may each have multiple different senses, while the substitution may only be appropriate in a one sense of the original term, and one sense of the particular candidate substitute. For example, the substitution of the term “pools” for the term “pool,” may be appropriate for the swimming-related sense of the term “pool,” but may not be appropriate in the billiard-related sense, or in the betting-related sense of the term “pool.”

To address this challenge, a search system may identify that an original term of a search query is a homograph or polysemous term, and may analyze query logs to determine different sets of alternate terms that may be associated with a particular sense of the original term. The search system may then identify search queries (or other text strings) that contain the original term, and may identify other search queries (or text strings) that are otherwise identical to these search queries, except for the fact that another term is substituted in place of the original query term. The search system can identify these other search queries by “wildcarding” the original term in these search queries, e.g., by replacing the original term with a placeholder, and by finding other search queries in a query log that match the search queries except for the portion of the search query filled by the placeholder.

For example, the search system can identify, using a query log, that an original term, “pool,” that is included in a search query has also occurred in other search queries, such as “pool toys” and “pool cues.” Replacing the original term “pool” in these search queries with a placeholder, and searching for the revised search queries can lead to the search system identifying other search queries, such as “bath toys,” and “swimming toys,” (for the search query “<blank> toys”), and “snooker cues,” and “billiard cues,” (for the search query “<blank> cues”).

Using the search queries that it has identified, the search system may build a set of alternate terms for the original term “pool.” From the above example, the search system may include the terms “bath,” “swimming,” “snooker,” and “billiard” in the set of alternate terms for the original term “pool.” The search queries that are identified as including the original term may also be stored for use in later phases of the process.

Although the above example describes generating sets of alternate terms by searching for substitutions in search queries, in other examples other text sources can be used. For example, data can be gathered based on the occurrences of words in documents. Given an initial sequence of words occurring in a document, e.g., [A B C D E], other occurrences of similar sequences of words in a corpus of documents, e.g., [A B*D E], may be evaluated to identify alternate terms.

For instance, a text corpus that stores the content of books can be analyzed to generate sets of alternate terms, such as in the case where the search system may observe the text strings “Call me Ishmael,” “Name me ‘Ishmael,’” and “Phone me, Ishmael” in the text corpus, and determine that “Name” and “Phone” are alternate terms for the word “Call.”

If not already identified, the search system may then identify search queries that contain the original query term. These search queries may be the same search queries, or different search queries, than the search queries identified above. For example, the search system may identify the search queries “pool hall,” (which an English-language speaker may intuitively associate with a billiards-related sense of the term “pool”) and “pool floats” (which an English-language speaker may intuitively associated with a swimming-related sense of the term “pool”).

Terms from the set of alternate terms are evaluated as pairs, to determine whether a particular pair of terms relates to the same sense of the original term, or to different senses, i.e., are disjoint. Accordingly, the search system proceeds by generating pairs of terms, e.g., (bath, swimming), (billiard, swimming), and (billiard, snooker), for the original term “pool.”

To determine whether the terms of a particular pair indicates a same word sense, the search system determines the quantity of search queries in the query log in which one term of the pair has been substituted for the original term, where it is observed that the other term of the pair has also been substituted for the original term. This quantity reflects a probability of the terms of the pair sharing the same word sense, under the assumption that the replacement of the original term by the alternate terms depends upon the sense of the original term.

For instance, for original term “pool,” the search query “pool hall,” and the pair of terms under evaluation (billiard, snooker), the search system may determine that the search queries “billiard hall” and “pool hall” are frequently submitted queries and, further, that “snooker hall” is also a frequently submitted query. The substitution of both “billiard” and “snooker” for “pool” in the search query “pool hall” suggests that “billiard” and “snooker” indicates a same sense of the original term “pool.”

Conversely, for the original term “pool,” the search query “pool hall,” and the pair of terms “billiard” and “swimming,” the system may determine that the search query “swimming hall” is not a frequently submitted query, despite the fact that the search queries “billiard hall” and “pool hall” are frequently submitted queries. From this information, the search system can gain the insight that the alternate terms “billiard” and “swimming” do not indicate a same sense of the original term “pool.”

The process of evaluating pairs of terms can be repeated using different search queries, in order to gain a more clear understanding of the relationships between terms. Specifically, by evaluating the pairs of terms against other search queries that include the original term, the search system can identify other groupings of terms within other senses of the original terms. For instance, by evaluating the pairs of terms against other search queries that include the original term, such as the search queries “pool splashing,” “pool deck,” or “pool drain,” the search system may further confirm that the alternate terms “billiard” and “swimming” do not indicate a same sense of the original term “pool,” but that the alternate terms “bath” and “swimming” do indicate a same sense of the original term “pool.”

The Search System

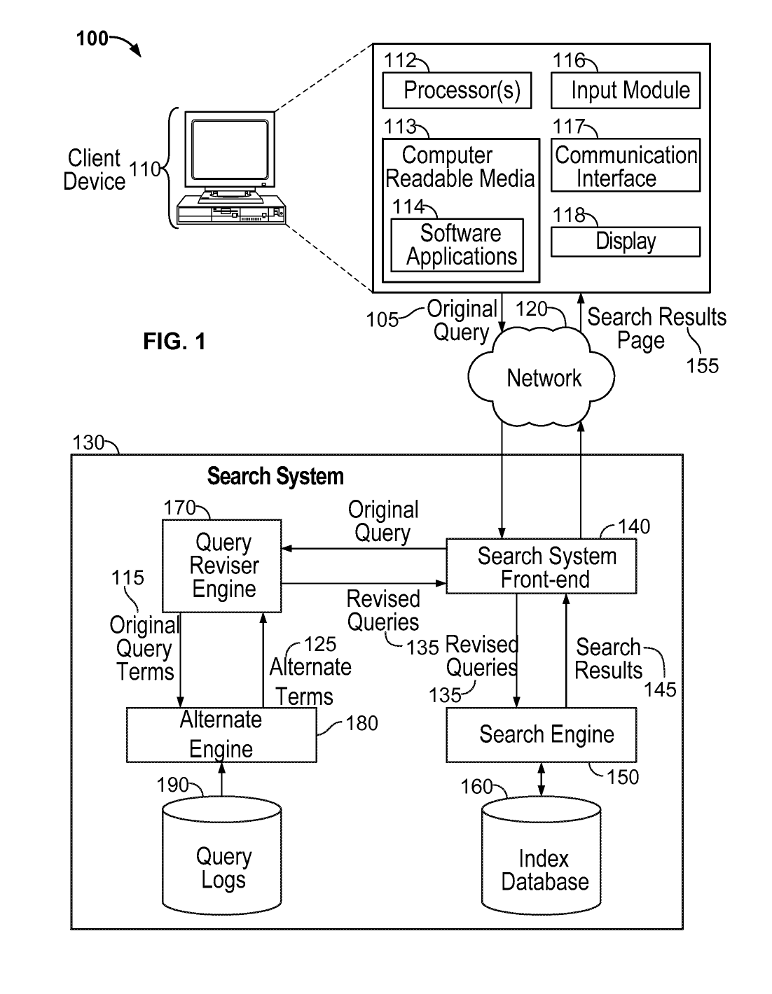

FIG. 1 is a diagram of an example system 100 that uses alternate terms to generate search results. Notably, and as described more fully below, the example system 100 includes a search system 130 that includes an a query reviser engine 170 and an alternate engine 180. The alternate engine 180 gathers statistical information that it uses to respond to requests from the query reviser engine 170 for determining whether, for a given search query, a candidate substitute term of a query term indicates a same sense as the query term, or a different sense. This statistical information may be generated by the alternate engine 180 before or after receiving such a request.

In general, the system 100 includes a client device 110 coupled to a search system 130 over a network 120. The search system 130 receives a query 105, referred to by this specification as the “original query” or an “initial query,” from the client device 110 over network 120, and the search system 130 provides a search results page 155 that presents search results 145 that the search system 130 identifies as being responsive to the query 105 to the client device 110 over the network 120.

The search results 145 identified by the search system 130 can include one or more search results that were identified as being responsive to queries that are different than the original query 105. The other queries can be obtained or generated in numerous ways, including by revising or expanding the original query 105 to include terms that are identifies as good substitutes for the terms 115 of the original query 105.

The search system 130 can be implemented as, for example, computer programs running on one or more computers in one or more locations that are coupled to each other through a network. The search system 130 includes a search system front-end 140 (or a “gateway server”) to coordinate requests between other parts of the search system 130 and the client device 110. The search system 130 also includes a search engine 150, a query reviser engine 170, and a alternate engine 180.

As used by this specification, an “engine” (or “software engine”) refers to a software implemented input/output system that provides an output that is different than the input. An engine may be an encoded block of functionality, such as a library, a platform, Software Development Kit (“SDK”), or an object. The network 120 may include, for example, a wireless cellular network, a wireless local area network (WLAN) or Wi-Fi network, a Third Generation (3G) or Fourth Generation (4G) mobile telecommunications network, a wired Ethernet network, a private network such as an intranet, a public network such as the Internet, or any appropriate combination thereof.

The search system front-end 140, search engine 150, query reviser engine 170, and alternate engine 180 can be implemented on any appropriate type of computing device (e.g., servers, mobile phones, tablet computers, music players, e-book readers, wearable computer, laptop or desktop computers, PDAs, smart phones, or other stationary or portable devices) that includes one or more processors and computer readable media. Among other components, the client device 110 includes one or more processors 112, computer readable media 113 that store software applications 114 (e.g. a browser or layout engine), an input module 116 (e.g., a keyboard or mouse), communication interface 117, and a display 118. The computing device or devices that implement the search system front-end 140, the query reviser engine 170, and the search engine 150 may include similar or different components.

In general, the search system front-end 140 receives the original query 105 from client device 110, and routes the original query 105 to the appropriate engines so that the search engine results page 155 may be generated. In some implementations, routing occurs by referencing static routing tables, or routing may occur based on the current network load of an engine, so as to accomplish a load balancing function. The search system front-end 140 also provides the resulting search engine results page 155 to the client device 110. In doing so, the search system front-end 140 acts as a gateway, or interface, between the client device 110 and the search engine 150. In some implementations, the search system 130 contains many thousands of computing devices to execute for the queries that are processed by the search system 130.

Two or more of the search system front-end 140, the query reviser engine 170, and the search engine 150 may be implemented on the same computing device, or on different computing devices. Because the search engine results page 155 is generated based on the collective activity of the search system front-end 140, the query reviser engine 170, and the search engine 150, the user of the client device 110 may refer to these engines collectively as a “search engine.” This specification, however, refers to the search engine 150, and not the collection of engines, as the “search engine,” since the search engine 150 identifies the search results 145 in response to the user-submitted search query 105.

The search system front-end 140 generates a search results page 155 that identifies the search results 145. Each of the search results 145 can include, for example, titles, text snippets, images, links, reviews, or other information. The query terms 115 or the alternate terms 125 that appear in the search results 145 can be formatted in a particular way, for example, in bold print. The search system front-end 140 transmits code (e.g., HyperText Markup Language code or eXtensible Markup Language code) for the search results page 155 to the client device 110 over the network 120, so that the client device 110 can display the search results page 155.

The client device 110 invokes the transmitted code, e.g., using a layout engine, and displays the search results page 155 on the display 118. The terms 115 of the original query 105 are displayed in a query box (or “search box”), located for example, on the top of the search results page 155, and some of the search results 145 are displayed in a search results block, for example, on the left-hand side of the search results page 155.

The query reviser engine 170 may use a variety of signals to identify candidate substitutes for query terms. In one example, the query reviser engine 170 may access the query logs 190, or a processed version of the query logs 190, to identify candidate substitutes.

When the query reviser engine 170 receives an original search query 105 that contains original query terms 115 that may each have multiple senses, the query reviser engine 170 may provide the original search query 105 to the alternate engine 180 and may request that the alternate engine 180 identify alternate terms 125 that may be used as candidate substitutes to expand the original search query 105 based, for example, on context information associated with the original search query 105, and/or using statistics that the alternate engine 180 has obtained or generated regarding the different senses of the original query terms 115.

When the original query 105 does not contain enough context for the alternate engine 180 to select the appropriate alternate terms 125 on this basis alone, the alternate engine 180 analyzes the data stored in the query logs 190 to assist in determining the appropriate alternate term to use in revising the original search query 105, or may consult data that stores the results of a prior analysis. For instance, the alternate engine 180 may analyze the query logs 190 to determine the appropriate alternate term for a particular original query term that is identified as a homograph or as a polysemous word.

When a user performs a web search using a search query that contains a term that is a homograph or a polysemous word, the query reviser engine 170 prompts the alternate engine 180 for information related to the term. The query reviser engine 170 indicates to the alternate engine 180 words that the query reviser engine 170 is considering as candidate substitutes for the original term.

For example, for a query that includes the terms [A B C D E], the query reviser engine 170 may indicate to the alternate engine 180 that [F] is a candidate substitute for [C]. The alternate engine 180 may consult a context-based term substitution model or rule set, and may determine that there is an insufficient basis for deciding that [F] should be treated as a substitute for [C] in a general context, or in context with other query terms [A], [B], [D], or [E] (either alone or in combination). Such a model may generated based on observing that the query [A B F D E] does not occur in the query log 190, or occurs less than a threshold number of times.

The alternate engine 180 may then consult the query logs 190 to identify alternate terms that have been submitted in the past, and that match the template or pattern [A B*D E]. Assuming that alternate terms [G], [H], and [I] are observed in this pattern in the query log 190 with a reasonable frequency, the alternate engine 180 evaluates whether the each of pairs ([F], [G]), ([F], [H]), and ([F], [I]) indicates a same sense for [C], or a different sense for [C].

If the pairs indicate the same sense for [C], then the alternate engine 180 indicates to the query reviser engine 170 that the sense of [C] in the query [A B C D E] is compatible with the candidate substitute [F]. Otherwise, the alternate engine 180 indicates to the query reviser engine 170 that the sense of [C] in the query [A B C D E] is not compatible with the candidate substitute [F]

For example, in attempting to locate information about Graceland, the Memphis home of Elvis Presley, a user may submit the query “Memphis Rocker House”. The query reviser engine 170 may inform the alternate engine 180 that it is considering treating the terms [CHAIR] and [MUSICIAN] as substitutes of the term [ROCKER].

The alternate engine 180 will determine whether it has sufficient basis, e.g., by consulting a term substitution model or rule base, to determine that either or both of the terms [CHAIR] or [MUSICIAN] should be treated as substitutes for the term [ROCKER], either in the general context, or in context with the other query terms [MEMPHIS] and/or [HOUSE]. For the sake of this example, it will be assumed that no such basis, or an insufficient basis, exists.

The alternate engine 180 will then consult the query logs (or other text corpora) to identify alternate terms that match the pattern [MEMPHIS*HOUSE]. Assuming that alternate terms [ELVIS] and [NEW] are observed in this pattern with the highest respective frequency, the alternate engine 180 evaluates that, for [ROCKER], the pairs ([MUSICIAN], [ELVIS]) indicate the same sense, and ([MUSICIAN], [NEW]) does not indicate the same sense. The alternate engine may further evaluate that, for [CHAIR], the pairs ([CHAIR], [ELVIS]) and ([CHAIR], [NEW]) do not indicate the same sense.

As a result, the alternate engine 180 informs the query reviser engine 170 that, for the query [MEMPHIS ROCKER HOUSE], [MUSICIAN] should be treated as a substitute of [ROCKER], and that [CHAIR] should not be treated as a substitute of [ROCKER]. For example, in response to receiving a request from the query reviser engine 170 to evaluate the candidate substitutes [CHAIR] and [MUSICIAN] for the term [ROCKER] in the query [MEMPHIS ROCKER HOUSE], the alternate engine 180 may respond by indicating that only the alternate term [MUSICIAN] should be treated as a candidate substitute.

Although FIG. 1 describes the operation of the system 100 in terms of an on-line process, in which candidate substitutes and/or alternate terms for particular terms are identified after the original search query is received, in additional off-line implementations the identification of candidate substitutes and/or alternate terms for particular terms may occur before receiving a search query that includes the particular term among its query terms. For example, search queries, e.g., past queries from a query log or other source, may be processed by the search system 130 to identify terms that should be treated as substitutes for the terms of the search queries. The resulting information can be used at a later point, for example to respond to a search query that is submitted by a user at a later time, or as training data for a machine learning system that predicts good substitute terms based on query context.

Logical Description of the Computation of Statistical Information

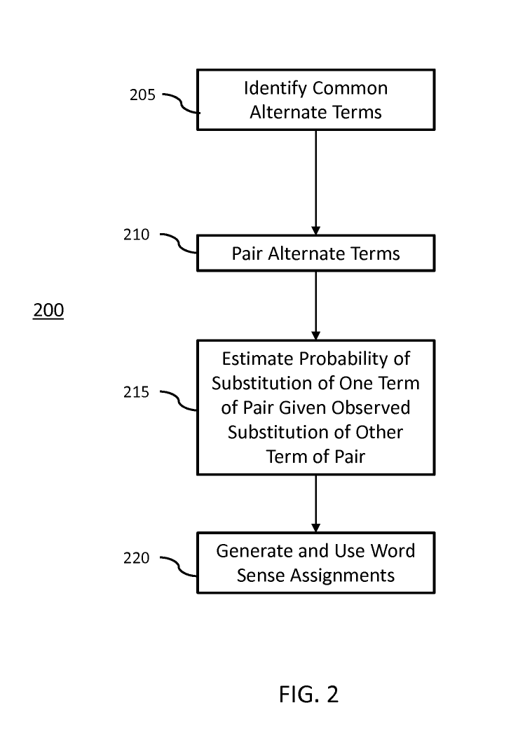

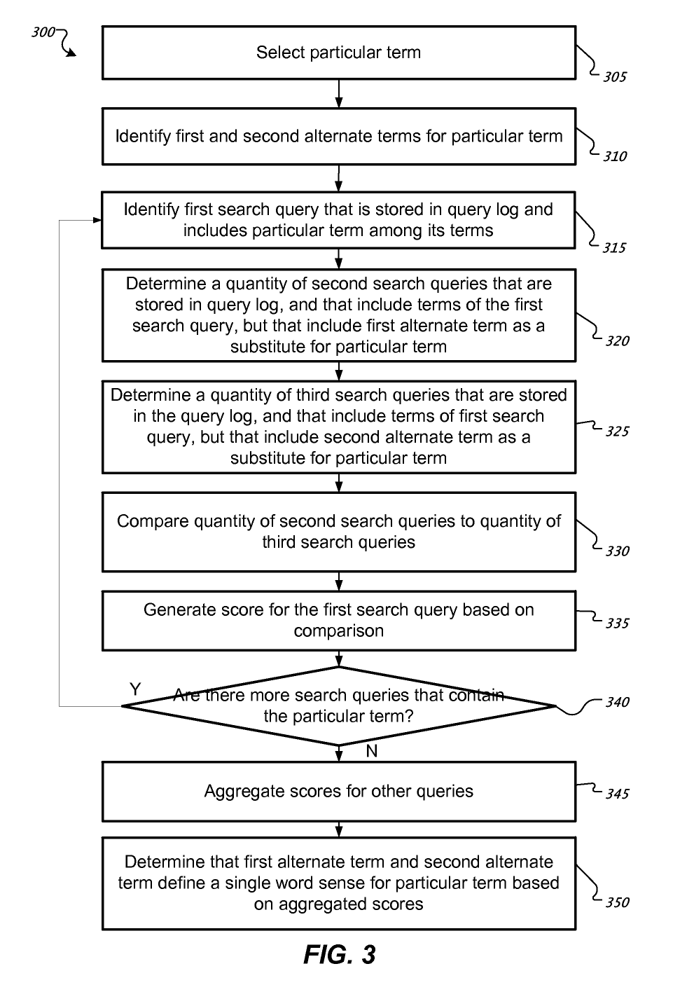

FIGS. 2 and 3 are flowcharts that show example methods 200, 300 for identifying words that are appropriate alternate terms for a particular word, when the particular word is being used in a particular word sense. Briefly, because it is difficult to determine whether a particular substitution for a homograph or a polysemous term is appropriate in a particular context, the methods 200, 300 use information that has been gathered about terms that are known, through analysis of empirical data, to be good substitutes for the homograph or polysemous term, when the homograph or polysemous terms is used in a particular word sense, as evidence to confirm whether or not a particular substitution is appropriate.

The methods 200, 300 both reflect the fact that the senses of an original term can be distinguished by how the original term alternates with other terms. Said another way, the senses of the original term can be indicated by the other terms that could replace the word in context, and still make sense. Generally speaking, the methods 200, 300 each includes four phases, which may be performed off-line, i.e., before a search query that is being rewritten or expanded is received, or on-line, i.e., after a search query that is being rewritten or expanded has been received.

First Example Process

In FIG. 2, in the first phase 205, common alternate terms for a particular homograph or polysemous term are collected. The first phase 205 may include selecting a term, and selecting a string of text, such as a past search query, that includes the term. The term is wildcarded in the string of text, and other strings of text that match the wildcarded string are identified.

Terms that have been substituted for the selected term in the other strings of text are identified, and a list of the n most frequently occurring of those terms is output. In one example implementation, the list includes the fifty most frequently occurring terms. For instance, for the original term “pool,” the method 200 may output a list that includes the alternate terms “billiard,” “snooker,” “bath,” and “swimming,” among other terms.

In the first phase 205, the data that is used as evidence of the in-context replacement of an original term is alternative search queries that have been received by a search system, that differ only with the original term being replaced by other terms, under the assumption that a user that submitted the original term with the other terms did so without changing the sense of the original term. The other terms define the set of alternate terms for the original term, when the original term occurs with a particular sense.

In the second phase 210, the alternate terms are paired for evaluation. For instance, the method 200 may output the following pairs: (billiard, snooker), (billiard, bath), (billiard, swimming), (snooker, bath), (snooker, swimming), and (bath, swimming). The pairs may or may not include two pairs of the same two terms, in which the order of the terms is reversed, such as the case where the pairs (bath, swimming) and (swimming, bath) are output for independent analysis.

In the third phase 215, the query log or other text corpus is analyzed in order to collect data about each pair, particularly, observations about the use of one alternate term of the pair as a substitute for the particular homograph or polysemous term, given known use of the other alternate term of the pair as a substitute for the particular homograph or polysemous term.

For example, for each pair of alternate terms (B, C) of an original term (A), and for one or more past queries that include the original term (A), P(AwB|AwC) is computed, representing a probability of an A to C substitution, when an A to B substitution has been observed, or has been frequently observed. For instance, for the pair of alternate terms (billiard, swimming), the query log may include entries for both “pool cue” and “billiard cue,” indicating that that the term “billiard” has been substituted for the term “pool” in the query “pool cue.” The query log may not include entries, or may include few entries, for “swimming cue,” indicating that the term “swimming” has not been substituted for the term “pool” in the query “pool cue,” even though the term “billiard” has been substituted for the term “pool.”

The occurrence of the A to B substitution and the A to C substitution could also be detected in other text corpora instead of, or in addition to, a query log. For instance, sequences of words that include the original term A could be identified in a text corpus, e.g., a news corpus, a patent corpus, a book corpus, or a shopping corpus. The probabilities noted above can be calculated based on whether, or the extent to which, similar strings that differ only in the A to B and/or A to C substitutions occur in the same corpus.

In the final phase 220, the alternate terms are assigned to the various senses of the particular homograph or polysemous term, and the search system makes various determinations about the particular homograph or polysemous term, or about the alternate terms, based on the assignments. From the above example, a search system can determine that alternate terms “billiard” and “swimming” are disjoint, and are not alternates for a single word sense of the term “pool.” The data collected may be represented, either visually or otherwise, in numerous ways, such as by using a matrix of terms, by clustering or grouping terms or senses, or through any other approach.

Notably, although the method 200 may result in the assignment of alternate terms to different sense of the original term, the actual senses themselves of the original terms are not observed, although the environment in which the senses occur is observed vis-a-vis the previously submitted search queries, helping to constrain the set of alternate terms. Thus, for the original term “pool” and the context [indoor <blank> diving board], alternate terms that are likely to be observed may include terms such as “swimming,” “recreation,” “aquatics facility,” “team.” From this set of alternate terms in this particular context, other alternate terms that are incompatible may be identified and rejected.

Second Example Process

In FIG. 3, the method 300 begins when, during stage 305, an original term that is identified as a homograph or polysemous term is selected. The original term may include one word, or more than one word.

In one example, when a user of a search system enters the query terms “Virginia chicken,” the search system may identify that the original term “chicken” is a polysemous term, as one sense of the term “chicken” refers to a living, domesticated fowl, and another sense of the term “chicken” refers to the type of poultry that is obtained from that animal. Terms that are homographs or polysemous words may be included on, and identified from, lists of homographs or polysemous words, or the user of a search system may explicitly indicate that a certain term is a homograph or polysemous word. Alternatively, a term may be identified as polysemous, or potentially polysemous, if it is not included on a list of grammatical function words.

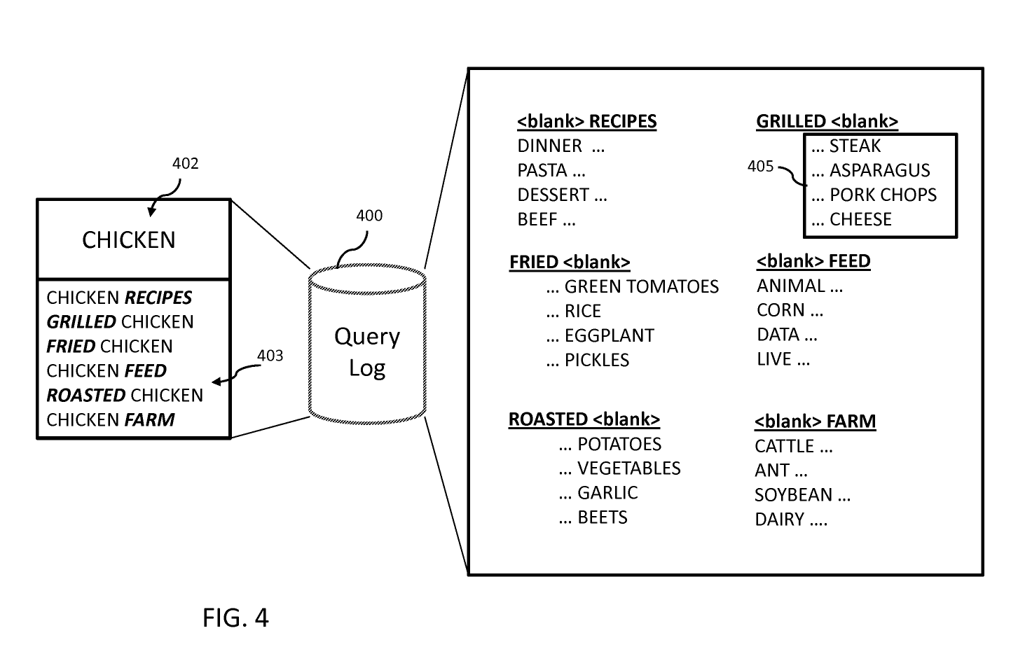

During stage 310, alternate terms for the original term are identified. In one example implementation, a text repository, such as a query log or other text corpus, may be analyzed in order to identify alternate terms. For instance, and as shown in FIG. 4, which shows the example contents of the query log 400, the query log 400 may identify past-submitted search queries 403 “chicken recipes,” “grilled chicken,” “fried chicken,” “chicken feed,” “roasted chicken,” and “chicken farm,” among other search queries that include the original term 402 “chicken.” In some implementations, all queries that are stored in the query log are searched, while in other implementations only certain popular search queries, or recent search queries, are analyzed.

In method 300, alternative search queries that have been received by a search system, that differ only in that the original term has been replaced by other terms, are used as evidence of the in-context replacement of an original term. The use of alternative search queries operates under the assumption that, in context, when one term is replaced by another term in two separate search queries, both terms likely indicate the same sense, regardless of whether the two queries were submitted by the same user or by different users. The other terms that replace the original query term in the various alternative search queries define the set of alternate terms for the original term, when the original term occurs with a particular sense.

The identified search queries 403 can be used to build a set of alternate terms. For example, the original term 402 can be replaced with a placeholder in the identified search queries 403, and the query log can be searched for other queries that match the revised query except for the placeholder, in order to identify other terms that have been substituted for the original term 402. These terms that have been substituted for the original term 402 in the past-submitted search queries can be designated as alternate terms, for further processing.

For instance, the query log 400 can be searched for queries that match the pattern “grilled <blank>,” to identify a set 405 of alternate terms that includes the terms “steak,” “asparagus,” “pork chops,” and “cheese.” In the example of FIG. 4, searching all of the identified search queries 403 for alternate terms results in a set of alternate terms for the original term 402 “chicken,” that includes “dinner,” “pasta,” “dessert,” “beef,” “steak,” “asparagus,” “pork chops,” “cheese,” “green tomatoes,” “rice,” “eggplant,” “pickles,” “animal,” “corn,” “data,” “live,” “potatoes,” “vegetables,” “garlic,” “beets,” “cattle,” “ant,” “soybean,” and “dairy.”

Pairs of alternate terms, e.g., (beef, pasta) and (beef, bird) are selected for further evaluation, to determine whether the terms of each pair indicate the same sense of the original term 402. Evaluating terms as pairs is effective, under the assumption that the replacement of the original term by the alternate terms depends upon the sense of the original term.

During stage 315, a search query that includes the original term is selected. The selected search query may be one of the queries that was selected in stage 310, or a different search query may be selected. For instance, a search query “chicken marinade” may be selected based on the original term “chicken.” The selected search query may be the most popular search query that contains the original term, for example, a most frequently submitted search query that includes the original term, within a particular time period. Alternatively, the selected search query may be a random search query that includes the original term, or the first search query that is encountered in the query log, that includes the original term.

For the pair of candidate terms, a first quantity is determined, reflecting the quantity of search queries that (i) are stored in the query log, (ii) otherwise include terms of the first search query, and (iii) include a first alternate terms of the pair as a substitute for the particular term. The quantity may be expressed as a count of queries, as a percentage of the overall number of search queries that are analyzed in the query log, or as some other metric.

Each search query that satisfies these criteria can increment a score for the pair of terms by a predetermined value, such as 1.0. Alternatively, the amount by which a particular query affects the overall score for a pair of terms can depend upon the quantity of occurrences of the search query, substituted by the first term of the pair, and/or the quantity of occurrences of the search query, substituted by the second term of the pair.

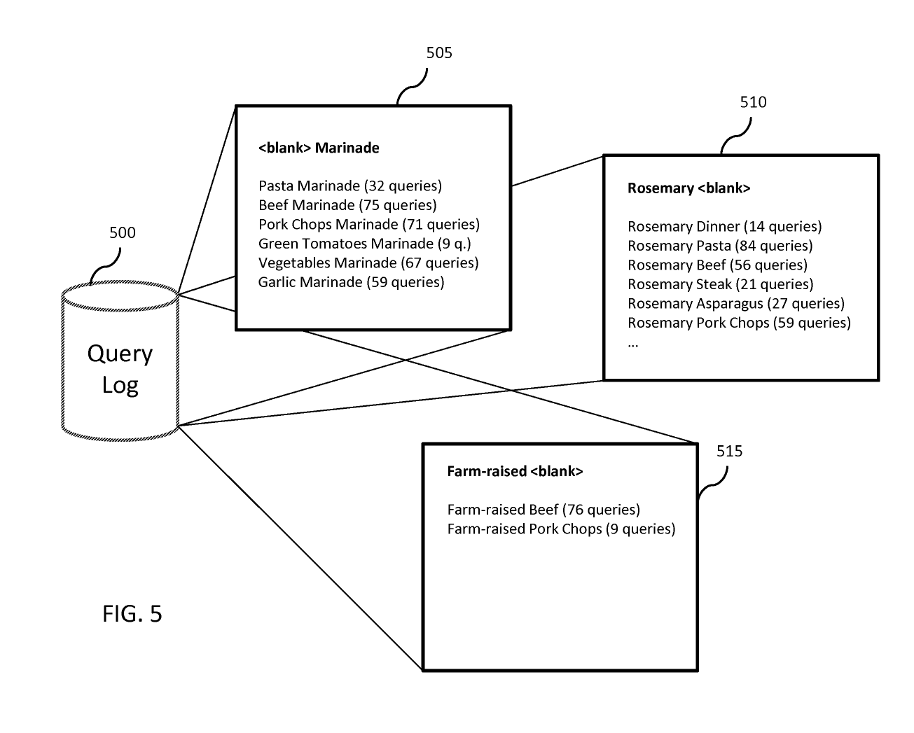

FIG. 5 shows the example contents of a query log 500. Starting in portion 505, for the pair of candidate terms (beef, pasta) and the search query “chicken marinade,” one or more entries are located for “beef marinade” in the query log, indicating that the search query “beef marinade” was included in 75 search queries. Assuming that 75 search queries satisfies a minimum quantity threshold, the occurrence of these 75 search queries in the query log suggests that, in at least one sense of the word “chicken,” the word “beef' is a good substitute.

For the pair of candidate terms (beef, bird) and the search query “chicken marinade,” the same entry or entries are located for “beef marinade” in the query log, again indicating that the search query “beef marinade” was included in 75 search queries. Because the term “beef” had already been evaluated in context with the search query “chicken marinade,” the quantity may be determined by looking up the result of the previous evaluation, instead of performing the evaluation again.

During the stage 325, for the pair of candidate terms, a second quantity is determined, reflecting the quantity of search queries that (i) are stored in the query log, (ii) otherwise include terms of the first search query, and (iii) include a second alternate term of the pair as a substitute for the particular term. The quantity may be expressed as a count of queries, as a percentage of the overall number of search queries that are analyzed in the query log, or as some other metric.

As shown in portion 505 of FIG. 5, having observed that an entry exists for “beef marinade,” one or more other entries are located for “pasta marinade” in the query log, indicating that the search query “pasta marinade” was included in 32 search queries. The fact that “beef” and “pasta” were both included in a significant number of “<blank> marinade” queries suggests not only that, in one sense of the word “chicken,” the word “pasta” is a good substitute, but also suggests that “beef” and “pasta” relate to the same sense of the word “chicken.”

For the pair (beef, bird), no entries are located for “bird marinade” in the query log. The fact that “beef” was included in a significant number of “<blank> marinade” search queries, but that no “bird marinade” search queries were located suggests that the terms “beef” and “bird” are disjoint with regard to any particular sense of the word “chicken.”

During stage 330, the first quantity is compared to the second quantity and, based on the comparison, a score is generated for the pair during stage 335. In some implementations, the score is based on a ratio of the first number to the second number, or an aggregate of the first number and the second number. The score may reflect the extent to which the terms of the pair map to the same sense of the original term.

The fact alone that “beef” and “pasta” were both included in a significant number of “<blank> marinade” queries may be sufficient to increment an overall score for these terms by a predetermined value, in context with this particular search query. Alternatively, the value by which the overall score for these terms may be determined based on the absolute or relative occurrence counts of the search queries in which each term of the pair was substituted for the original term.

For instance, a relatively equal number of occurrences of search queries in which each term of the pair was substituted for the original term may reflect that the terms of the pair indicate the same word sense, in the particular sense of the original term, and may increase an overall score for these terms by a higher value, e.g., a value approaching or including 1.0. A large disparity in the respective number of occurrences of search queries in which each term of the pair was substituted for the original term may reflect that the terms of the pair are disjoint in indicating the same word sense, in the particular sense of the original term, and may increase an overall score for these terms by a lesser value, e.g., a value approaching or including 0.0.

During stage 340, it is determined whether the pairs of terms should be evaluated against additional search queries that include the original term. If not, an aggregated score for each pair of terms is determined, during stage 345, and, based on the aggregated score, the terms of the pair are designated as belonging to a particular sense of the original term, or as being disjoint with respect to the particular sense, during stage 350. The aggregated score may reflect the number of search queries against which the pair of terms were evaluated, that included a substitution of one term of the pair when a substitution of the other term of the pair had also been made.

The pairs of terms may also be evaluated against additional search queries that include the original term, to provide further evidence as to whether the pairs of terms are consistent or disjoint with respect to a particular sense of an original term. As shown in portion 510 of FIG. 5, for instance, in evaluating the pair of terms (beef, pasta) against the search query “Rosemary <blank>,” it may be determined that a significant number of “Rosemary Beef” and “Rosemary Pasta” search queries exist in the query log. This information further suggest that, not only is “beef” a good substitute for one sense of the word “chicken,” but also that “beef” and “pasta” are good substitutes for the same sense of the word “chicken.” This insight is reflected in the score for the pair (beef, pasta) in context with the search query “Rosemary <blank>,” which may be aggregated with the score for the pair (beef, pasta) in context with the search query “<blank> Marinade,” to further evidence the relationship of the terms of the pair with respect to the sense of the original term “chicken.”

The pair of terms (beef, bird) can also be evaluated against the search query “Rosemary <blank>.” In so, it may be determined that no “Rosemary Bird” search queries exist in the query log, bolstering the notion that “beef” and “bird” are disjoint with respect to one sense of the word “chicken.”

As shown in portion 515 of FIG. 5, the pair of terms (beef, pasta) can be evaluated against the search query “Farm-raised <blank>.” The fact that a significant number of “Farm-raised Beef” queries are included in the query log, but that no “Farm-raised pasta” queries are included in the query log, suggests that the terms “beef” and “pasta” are disjoint with respect to one particular sense of the word “chicken.” The results of this analysis, however, can be aggregated with the results of the analysis of the pair of terms (beef, pasta) against the search queries “<blank> Marinade” and “Rosemary <blank>,” which may result in an overall conclusion that the pair of terms (beef, pasta) are good substitutes for the one sense of the word “chicken.” This is true despite the fact that analysis of the pair of terms (beef, pasta) against some search queries, such as “Farm-raised <blank>” suggests that the terms are disjoint in some contexts.

When the pair of terms (beef, bird) are evaluated against the search query “Farm-raised <blank>,” it is discovered that a significant number of “Farm-raised Beef” queries are included in the query log, but that no “Farm-raised bird” queries are included in the query log. This further suggests that the terms “beef” and “bird” are disjoint with respect to one particular sense of the word “chicken,” which is consistent with the results of analyzing the pair of terms (beef, bird) against the search queries “<blank> Marinade” and “Rosemary <blank>.” These results, when aggregated, may lead to an overall conclusion that the pair of terms (beef, bird) are not good substitutes for the one sense of the word “chicken,” although they both might be good substitutes for different senses of the word “chicken.”

The alternate terms are assigned to the various senses of the particular homograph or polysemous term, and the search system makes various determinations about the particular homograph or polysemous term, or about candidate substitute terms, based on the assignments. For example, when a search query is received that contains a query term that has multiple senses, alternate terms can be identified for use in expanding the original search query based on these statistics that have been gathered regarding the different senses of the original query term. For instance, and from the above example, a search system can determine that “beef” and “bird” are disjoint, and are not alternates for a single word sense of the term “chicken.”

The data collected may be represented, either visually or otherwise, in numerous ways, such as by using a matrix of terms, by clustering or grouping terms or senses, or through any other approach. Once candidate substitutes have been assigned to various senses of various terms, this information can be used in a variety of different ways. For example, this information can be used to classify contexts or other occurrences of a term as compatible with or incompatible with other contexts or with a candidate substitute of interest.

Computer-Implementation

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
obtaining a search query;
identifying a particular term from the search query;
determining that the particular term is, or is potentially, a polyseme or a homograph;
in response to determining that the particular term is, or is potentially, a polyseme or a homograph, identifying a first alternate term and a second alternate term for the particular term;
identifying a first sequence of terms that (i) occurs in a text corpus, (ii) includes the particular term among its terms, and (iii) is different than the search query;
determining a number of occurrences of a second sequence of terms in the text corpus, wherein the second sequence of terms differs from the first sequence of terms only in that the first alternate term is substituted for the particular term;
determining a number of occurrences of a third sequence of terms in the text corpus, wherein the third sequence of terms differs from the first sequence of terms only in that the second alternate term is substituted for the particular term; and
determining, based at least on the number of occurrences of the second sequence of terms in the text corpus and the number of occurrences of the third sequence of terms in the text corpus, whether the first alternate term and the second alternate term indicate a same word sense of the particular term.

2-20. (canceled)

21. The method of claim 1, wherein the first alternate term and the second alternate term comprises query term substitutions for the particular term.

22. The method of claim 1, wherein:
the text corpus comprises a query log, and
each sequence of terms comprises a search query that is stored in the query log, and that is different from the search query that includes the particular term.

23. The method of claim 1, wherein the first alternate term and the second alternate term are identified from a query log after the search query is received.

24. The method of claim 1, comprising:
determining whether to expand the search query to include the first alternate term or the second alternate term based on determining that the first alternate term and the second alternate term indicate a same word sense of the particular term.

25. The method of claim 1, wherein determining whether the first alternate term and the second alternate term indicate a same sense of the particular term comprises determining whether second sequence of terms and the third sequence of terms both occur in the text corpus.

26. The method of claim 1, wherein determining whether the first alternate term and the second alternate term indicate a same sense of the particular term comprises determining whether second sequence of terms and the third sequence of terms both occur in the text corpus more than a predetermined number of times.

27. The method of claim 1, comprising:
identifying a fourth sequence of terms that (i) occurs in the text corpus, (ii) includes the particular term among its terms, and (iii) is different than the search query and the sequence of terms;
determining a number of occurrences of a fifth sequence of terms in the text corpus, wherein the fifth sequence of terms differs from the fourth sequence of terms only in that the first alternate term is substituted for the particular term;
determining a number of occurrences of a sixth sequence of terms in the text corpus, wherein the sixth sequence of terms differs from the fourth sequence of terms only in that the second alternate term is substituted for the particular term; and
wherein determining whether the first alternate term and the second alternate term indicate the same word sense of the particular term is further based on the number of occurrences of the fifth sequence of terms in the text corpus and the number of occurrences of the sixth sequence of terms in the text corpus.

28. The method of claim 1, comprising:
comparing the number of occurrences of the second sequence of terms in the text corpus with the number of occurrences of the third sequence of terms in the text corpus; and
generating a score for a substitution of the particular term by the first alternate term or the second alternate term based on comparing the number of occurrences of the second sequence of terms in the text corpus with the number of occurrences of the third sequence of terms in the text corpus.

29. A system comprising:
one or more computers and one or more storage devices storing instructions that are operable, when executed by the one or more computers, to cause the one or more computers to perform operations comprising:
obtaining a search query;
identifying a particular term from the search query;
determining that the particular term is, or is potentially, a polyseme or a homograph;
in response to determining that the particular term is, or is potentially, a polyseme or a homograph, identifying a first alternate term and a second alternate term for the particular term;
identifying a first sequence of terms that (i) occurs in a text corpus, (ii) includes the particular term among its terms, and (iii) is different than the search query;
determining a number of occurrences of a second sequence of terms in the text corpus, wherein the second sequence of terms differs from the first sequence of terms only in that the first alternate term is substituted for the particular term;
determining a number of occurrences of a third sequence of terms in the text corpus, wherein the third sequence of terms differs from the first sequence of terms only in that the second alternate term is substituted for the particular term; and
determining, based at least on the number of occurrences of the second sequence of terms in the text corpus and the number of occurrences of the third sequence of terms in the text corpus, whether the first alternate term and the second alternate term indicate a same word sense of the particular term.

30. The system of claim 29, wherein the first alternate term and the second alternate term comprises query term substitutions for the particular term.

31. The system of claim 29, wherein:
the text corpus comprises a query log, and
each sequence of terms comprises a search query that is stored in the query log, and that is different from the search query that includes the particular term.

32. The system of claim 29, wherein the first alternate term and the second alternate term are identified from a query log after the search query is received.

33. The system of claim 29, wherein the operations comprise:
determining whether to expand the search query to include the first alternate term or the second alternate term based on determining that the first alternate term and the second alternate term indicate a same word sense of the particular term.

34. The system of claim 29, wherein determining whether the first alternate term and the second alternate term indicate a same sense of the particular term comprises determining whether second sequence of terms and the third sequence of terms both occur in the text corpus.

35. The system of claim 29, wherein determining whether the first alternate term and the second alternate term indicate a same sense of the particular term comprises determining whether second sequence of terms and the third sequence of terms both occur in the text corpus more than a predetermined number of times.

36. The system of claim 29, wherein the operations comprise:
identifying a fourth sequence of terms that (i) occurs in the text corpus, (ii) includes the particular term among its terms, and (iii) is different than the search query and the sequence of terms;
determining a number of occurrences of a fifth sequence of terms in the text corpus, wherein the fifth sequence of terms differs from the fourth sequence of terms only in that the first alternate term is substituted for the particular term;
determining a number of occurrences of a sixth sequence of terms in the text corpus, wherein the sixth sequence of terms differs from the fourth sequence of terms only in that the second alternate term is substituted for the particular term; and
wherein determining whether the first alternate term and the second alternate term indicate the same word sense of the particular term is further based on the number of occurrences of the fifth sequence of terms in the text corpus and the number of occurrences of the sixth sequence of terms in the text corpus.

37. The system of claim 29, wherein the operations comprise:
comparing the number of occurrences of the second sequence of terms in the text corpus with the number of occurrences of the third sequence of terms in the text corpus; and
generating a score for a substitution of the particular term by the first alternate term or the second alternate term based on comparing the number of occurrences of the second sequence of terms in the text corpus with the number of occurrences of the third sequence of terms in the text corpus.

38. A non-transitory computer-readable medium storing software comprising instructions executable by one or more computers which, upon such execution, cause the one or more computers to perform operations comprising:
obtaining a search query;
identifying a particular term from the search query;
determining that the particular term is, or is potentially, a polyseme or a homograph;
in response to determining that the particular term is, or is potentially, a polyseme or a homograph, identifying a first alternate term and a second alternate term for the particular term;
identifying a first sequence of terms that (i) occurs in a text corpus, (ii) includes the particular term among its terms, and (iii) is different than the search query;
determining a number of occurrences of a second sequence of terms in the text corpus, wherein the second sequence of terms differs from the first sequence of terms only in that the first alternate term is substituted for the particular term;
determining a number of occurrences of a third sequence of terms in the text corpus, wherein the third sequence of terms differs from the first sequence of terms only in that the second alternate term is substituted for the particular term; and
determining, based at least on the number of occurrences of the second sequence of terms in the text corpus and the number of occurrences of the third sequence of terms in the text corpus, whether the first alternate term and the second alternate term indicate a same word sense of the particular term.

39. The medium of claim 38, wherein the operations comprise:
identifying a fourth sequence of terms that (i) occurs in the text corpus, (ii) includes the particular term among its terms, and (iii) is different than the search query and the sequence of terms;
determining a number of occurrences of a fifth sequence of terms in the text corpus, wherein the fifth sequence of terms differs from the fourth sequence of terms only in that the first alternate term is substituted for the particular term;
determining a number of occurrences of a sixth sequence of terms in the text corpus, wherein the sixth sequence of terms differs from the fourth sequence of terms only in that the second alternate term is substituted for the particular term; and
wherein determining whether the first alternate term and the second alternate term indicate the same word sense of the particular term is further based on the number of occurrences of the fifth sequence of terms in the text corpus and the number of occurrences of the sixth sequence of terms in the text corpus.
